(19) United States
(12) Patent Application Publication
(10) Pub. No.: US 2006/0209100 A1
(43) Pub. Date: Sep. 21, 2006

(54) Illuminated ribbon cartridge

(76) Inventors: Scott T. Forest, Hope, NJ (US); Armando Lopez, Santa Ana, CA (US); Albert Van Grouw III, North Haledon, NJ (US)

Correspondence Address: STETINA BRUNDA GARRED & BRUCKER, 75 ENTERPRISE, SUITE 250, ALISO VIEJO, CA, 92656, US

(21) Appl. No.: 11/083,589

(22) Filed: Mar. 18, 2005

(51) Int. Cl. B41J 3/00

(52) U.S. Cl. 347/2

(57) ABSTRACT

A printer cartridge may define an internal cavity. The cartridge may have a body and a cover defining the internal cavity, and a light source may be disposed inside of the cartridge internal cavity. The light source may shine light through a notch formed in the body to illuminate a time card inserted into a time card time slot of a time clock. The light source may also shine light through an arrow shaped aperture to direct an employee that the appropriate time slot of the time card should be aligned under the arrow such that the printing mechanism may print the current time to the aligned time slot.

### CROSS-REFERENCE TO RELATED APPLICATIONS

Not Applicable

### STATEMENT RE: FEDERALLY SPONSORED RESEARCH/DEVELOPMENT

Not applicable.

### BACKGROUND OF THE INVENTION

The present invention relates generally to a printer cartridge of a time clock, and more particularly, to an internally illuminated printer cartridge to shine light on a time card inserted into the time clock.

Time clocks keep track of an employee's time worked. Each employee may be given a time card to record his/her time worked on the time card. The time card may have a plurality of time slots representing the days of the week (e.g., Monday, Tuesday, Wednesday, Thursday, Friday, Saturday and Sunday) and various times of the work day (e.g., start of work day, beginning of lunch, end of lunch and end of work day). The employee may record his/her time worked by inserting the time card into the time clock, aligning an appropriate time slot to a target area of a printing mechanism, and pressing a print button of the time clock so as to actuate the printing mechanism to indicate the current time on the aligned time slot. Since the time stamped onto the respective time slot may not be altered by the employee—the time clock is tamper proof, the recorded times are reflective of the time worked by the employee. However, to make the time clock tamper proof, the electronic components or the time clock adjustments must be made unavailable to the employee.

To this end, the electronic components of the time clock are covered by an opaque cover which has a small transparent window through which the employee may view the printing mechanism, target area of the printing mechanism and the time slot such that the employee may align the appropriate time slot to the printing mechanism target area. However, the opaque cover also does not allow much ambient light to shine onto the printing mechanism, printing mechanism target area and time slot; hence, the printing chamber which houses these components is not well lit making alignment of the time slot to the target area difficult. As such, many of the stamped times may be misaligned thereby difficult to read.

Accordingly, there is a need for an improved time clock.

### BRIEF SUMMARY OF THE INVENTION

The deficiency in the prior art is addressed by the present invention illustrated herein. In an aspect of the present invention, a light source (e.g., electroluminescent lamp), powered by the power source of the time clock—e.g., the electrical wall outlet, may be fabricated inside an internal cavity of a printer cartridge of a time clock. When the light source is illuminated, its light may shine through a notch formed in a body of the printer cartridge. This notch may be located on the body such that the light shining therethrough shines light onto the inserted time card to help employees better see an appropriate time slot and a target area of a printing mechanism.

In another aspect of the present invention, the printer cartridge body may also have an arrow shaped aperture. Light from the light source may also shine through this arrow shaped aperture. Since this arrow shaped aperture may be positioned above or aligned with a target area of the printing mechanism, it may be useful in intuitively communicating to employees that the appropriate time slot should be aligned directly underneath the arrow. In sum, the light shining through the notch and the arrow shaped aperture produces a more readable time card (1) by shining light onto the appropriate time slot and printing mechanism target area such that the employee is better able to align the appropriate time slot to the printing mechanism target area and (2) by illuminating an arrow pointed to the printing mechanism target area such that employees know where to align the appropriate time slot.

### BRIEF DESCRIPTION OF THE DRAWINGS

An illustrative and presently preferred embodiment of the invention is shown in the accompanying drawings in which:

FIG. 1 is a perspective view of a time card inserted into a time card slot of a time clock;

FIG. 2 is a perspective view of the time card illuminated via light shining through a notch of a printer cartridge, and a target area of a printing mechanism aligned with or directly underneath an illuminated arrow of the printer cartridge;

FIG. 3 is a top view of a time card illustrating a plurality of time slots;

FIG. 4 is an exploded perspective view of the printer cartridge showing a light source within a cartridge internal cavity and a male connector connected to the light source;

FIG. 5 is a perspective view of the printer cartridge inserted into a housing and attached thereto with clips; and

FIG. 6 is a perspective view of the housing of FIG. 5 and showing a female connector connectable to the male connector of FIG. 4 to provide power to the light source.

### DETAILED DESCRIPTION OF THE INVENTION

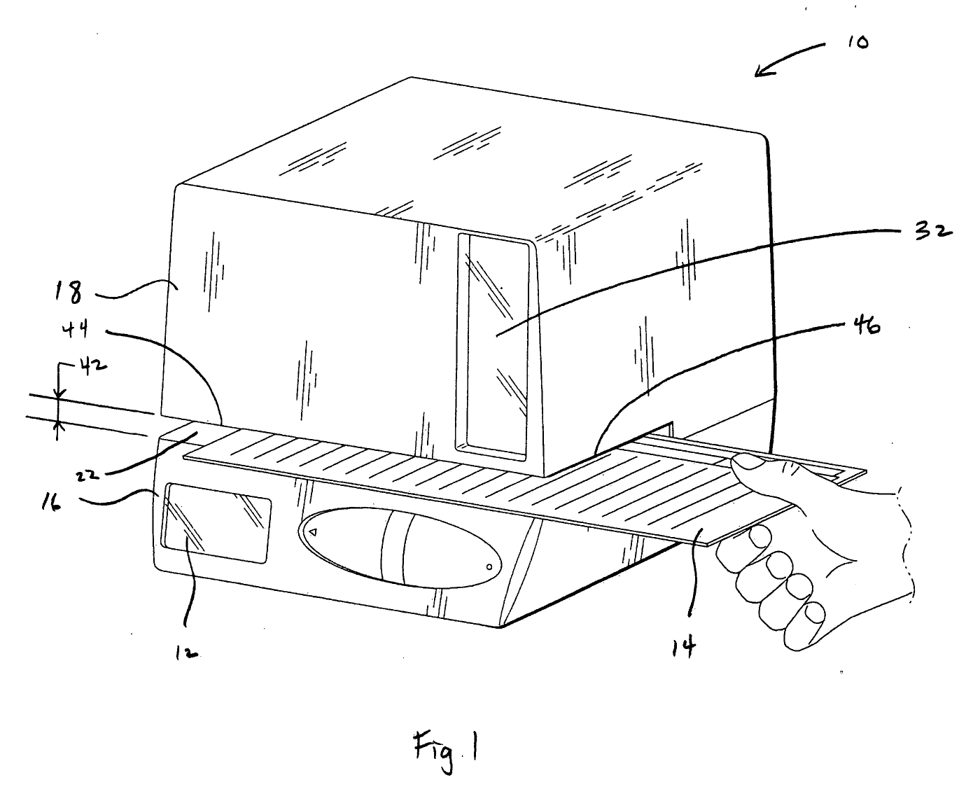

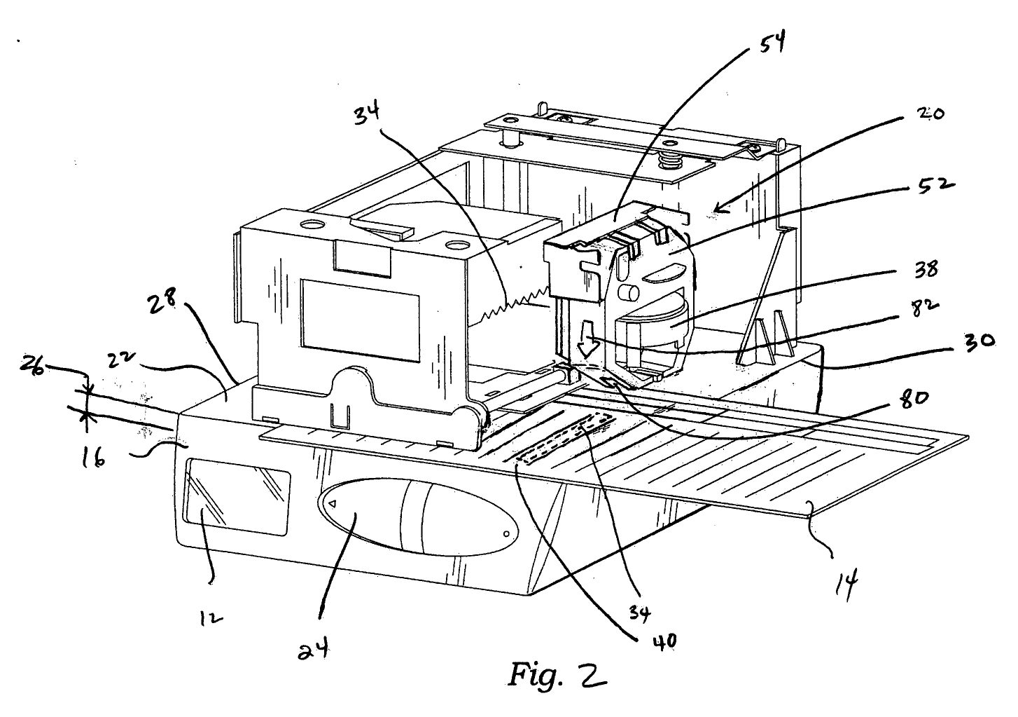

The figures referred to herein are for the purpose of illustrating the preferred embodiments of the present invention and not for the purpose of limiting the same. Referring now to FIG. 1, the same illustrates a time clock 10. The time clock 10 may stamp the current time which is also indicated by the clock 12 on a time card 14. The time clock 10 may comprise a base 16 and a cover 18. As shown in FIG. 2, electronic and mechanical components, such as the clock (e.g., digital or analog clock) 12, an electrical circuit, a printing mechanism 20, a printer platen 22 and a print button 24, may be attached to the base 16 and interconnected to each other. The printer platen 22 may be attached to the base 16 at a base upper portion 26 and extend from its left edge 28 to the right edge 30. The printing mechanism 20 may also be attached to the base 16 and positioned above the printer platen 22. The printing mechanism 20 may be traversed between an idle position (see FIG. 2) and a print position. In the idle position, the printing mechanism 20 does not block a user's line of sight through a print window 32 (see FIG. 1) of the cover 18 to a target area 34 (see FIG. 2) of the printing mechanism 20. In contrast, in the print position, the printing mechanism 20 is moved forward, via a rack 36 and pinion−behind the printing mechanism 20, over the target area 34, and a print head 38 is traversed downward onto an aligned time slot 40 (see FIG. 2) of the time card 14 and the target area 34. As such, the user's line of sight to the target area 34 is blocked by the printing mechanism 20 when it 20 is in the print position.

The electric circuit may be a processor or a plurality of electrical components attached to a printed circuit board (“PCB”). The electric circuit may also be in electrical communication with the printing mechanism 20 and a print button switch adjacent the print button 24 such that pressing (i.e., depressed position) the print button 24 traverses the printing mechanism 20 to the print position and releasing (i.e., released position) the print button 24 traverses the printing mechanism 20 to the idle position (see FIG. 2).

The print button 24 may be positioned adjacent to the print button switch which may be closed or opened and in electrical communication with the printing mechanism 20. When the print button 24 is pressed, then the print button switch is closed and the printing mechanism 20 is traversed to the print position. When the print button 24 is released, the print button switch is opened and the printing mechanism 20 is traversed to the idle position. It is further contemplated that the printing mechanism 20 is returned to the idle position once the printing mechanism 20 has printed the time on the aligned time slot 40 even if the print button 24 is maintained in the depressed position.

The cover 18 of the time clock 10 may encapsulate the printing mechanism 20, electric circuit, and other electronic and mechanical components of the time clock 10. The cover 18 may be attached to the base 16 and locked thereto such that the employee may not tamper with the printing mechanism 20, the electric circuit, the clock 12 or any other internal components of the time clock 10 to alter the current time displayed by the clock 12. The cover 18 may be placed adjacent to the printer platen 22 to form a time card slot 42 (see FIG. 1) between a longitudinal front edge 44 and lateral edges 46 of the cover 18 with the printer platen 22. The time card slot 42 provides a pathway for the time card to be inserted. Also, inserting the time card 14 into the time card slot 42 inserts the time card 14 between the printing mechanism 20 (see FIG. 2) and the printer platen 22 (see FIG. 2).

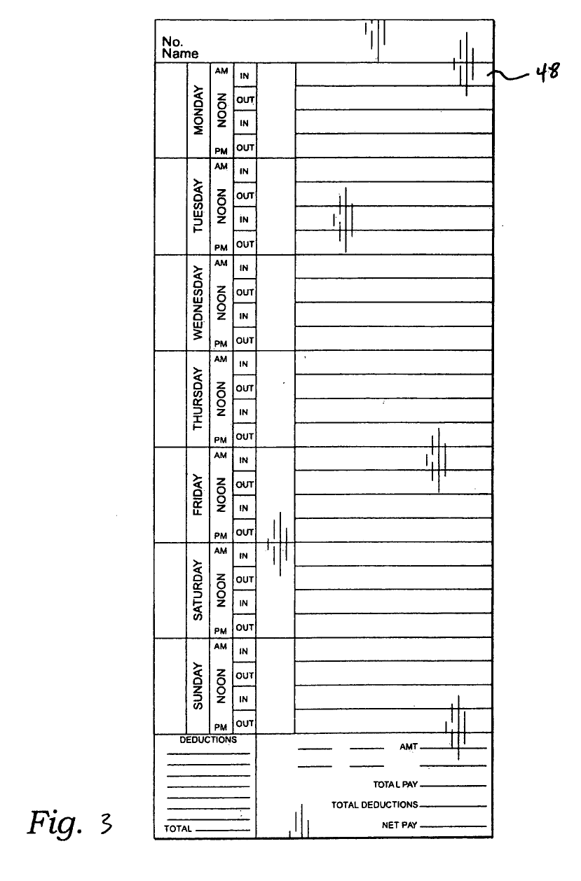

The time clock 10 may print, impress, or otherwise indicate the current time onto the aligned time slot 40 of the time card 14. As shown in FIG. 3, the time card 14 may be fabricated from paper or cardboard material and have indicia representative of an employee name, number, days of week (e.g., Monday, Tuesday, Wednesday, Thursday, Friday, Saturday and Sunday) and various times during the work day (e.g., start of work day, start of lunch, end of lunch and end of work day). Each day of the week in combination with the various times during the work day is assigned one time slot 48 on the time card 14. The time card 14 may be inserted into the time card slot 42; the appropriate time slot 48 aligned to the target area 34 of the printing mechanism 20; and the printing mechanism 20 traversed to the print position by depressing the print button 24. Once the printing mechanism 20 is traversed to the print position, the printing mechanism 20 prints, impresses or otherwise indicates the current time onto the aligned time slot 40 of the time card 14.

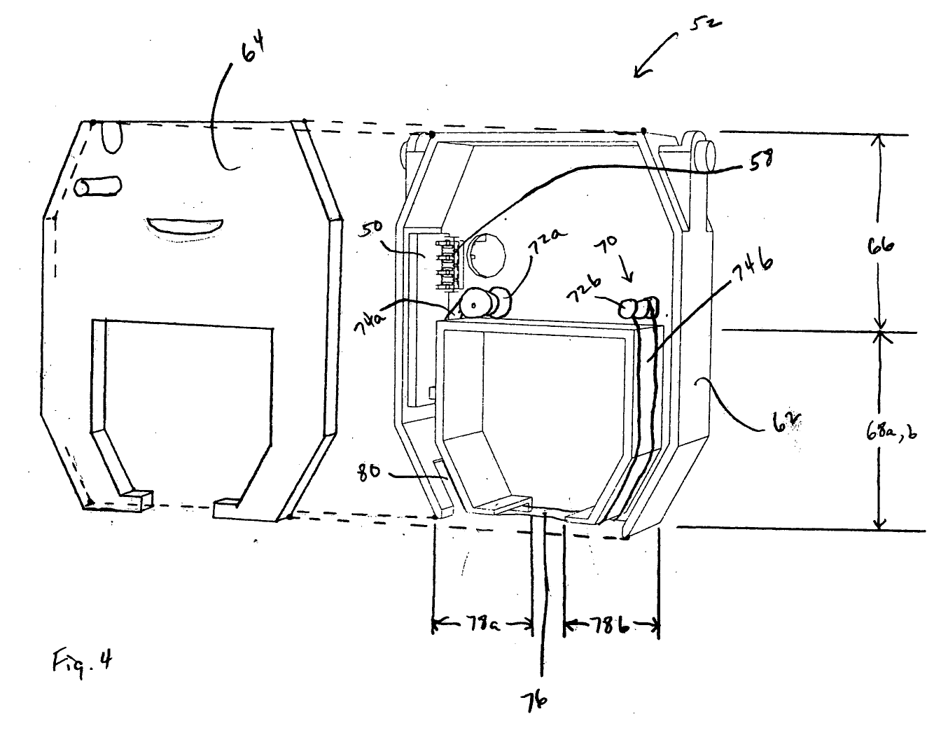

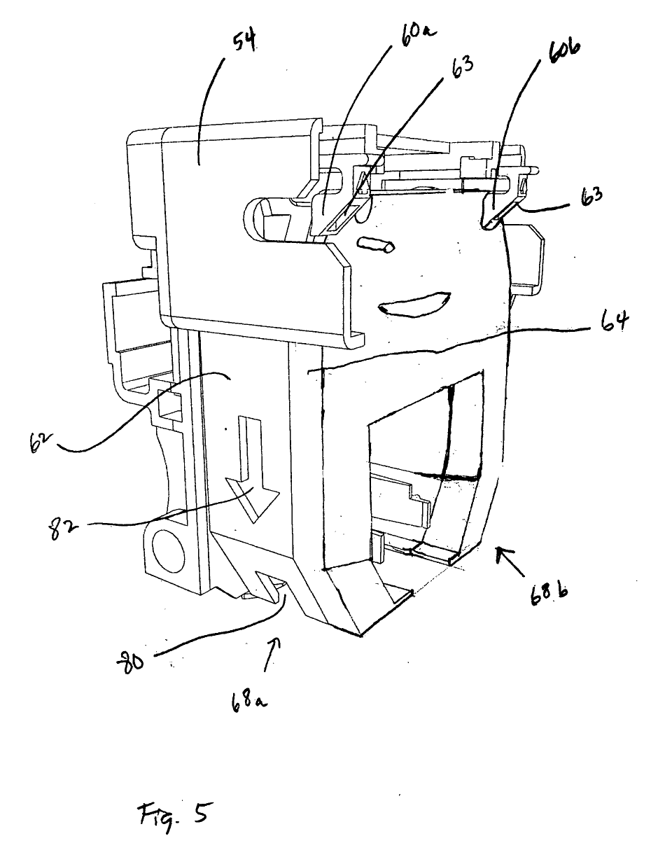

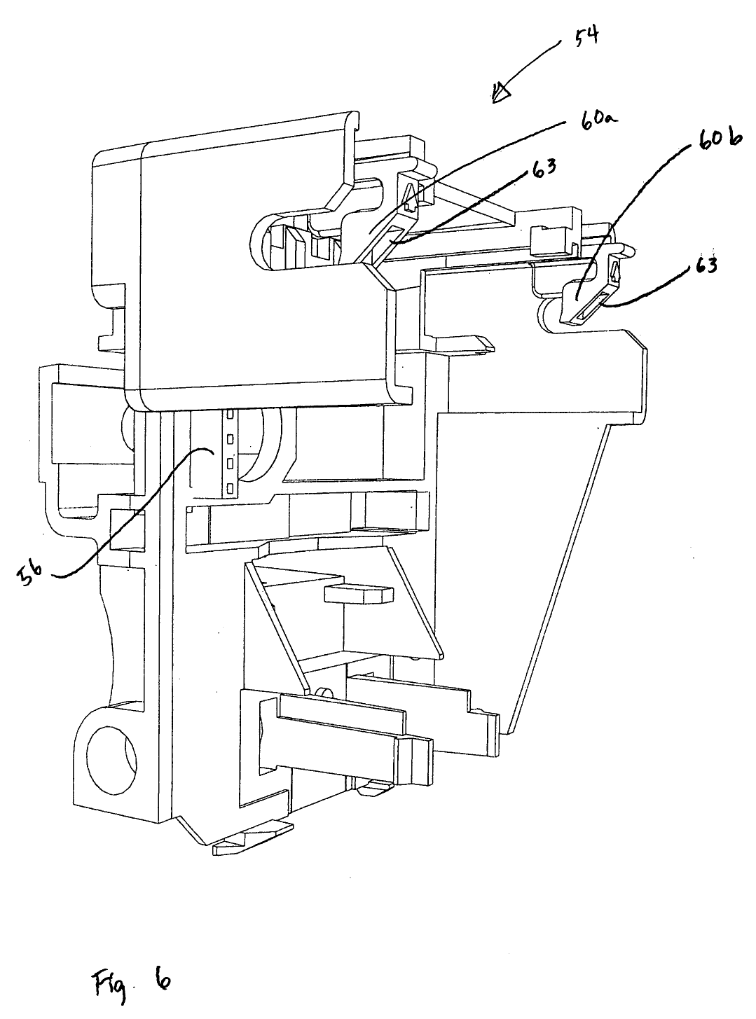

In aligning the time slot 48 to the printing mechanism target area 34, the time card 14 and time slot 48 may be illuminated via a light source 50 (see FIG. 4), powered via the power source of the time clock 10, located within a printer cartridge 52 (see FIGS. 2 and 4) of the printing mechanism 20 (see FIG. 2), as will be further discussed below. The printing mechanism 20 may comprise the printer cartridge 52, a housing 54 (see FIGS. 2 and 5) and the print head 38 (see FIG. 2). The housing 54 and the print head 38 may be attached to the base 16. Also, the printer cartridge 52 may be removeably attachable to the housing 54. 100221 Referring now to FIG. 6, the housing 54 may have a female connector 56 which is in electrical communication with the power source of the time clock 10—e.g., an electrical wall outlet. Also, the printer cartridge 52 (see FIG. 4) may have a male connector 58 removeably attachable to the female connector 56 and in electrical communication with the light source 50. The male and female connectors 58, 56 are respectively positioned on the housing 54 and the printer cartridge 52 such that when the printer cartridge 52 is attached to the housing 54, the male connector 58 is inserted into the female connector 56 to establish electrical communication from the time clock power source to the light source 50. If power is flowed through the established electrical communication path, then the light source 50 is turned on—light is illuminated. Conversely, when the printer cartridge 52 is removed from the housing 54, then the male connector 58 is removed from the female connector 56 to terminate the electrical communication between the time clock power source and the light source 50.

The housing 54 may further have two clips 60a, b (see FIG. 6) attached to upper portions of the housing 54. The housing 54 may also define a housing internal cavity which may be sized and configured to receive the printer cartridge 52 and the print head 38. The printer cartridge 52 may be removably attachable to the housing 54, and more particularly, the printer cartridge 52 may be removably insertable into the housing internal cavity. The printer cartridge 52, when inserted into the housing internal cavity, may be fixedly attached to the housing 54 by the two clips 60a, b, as shown in FIG. 5. In particular, a body 62 of the printer cartridge 52 may be pressed onto oblique surfaces 63 (see FIG. 6) of the clips 60a, b. The clips 60a, b may upwardly flex the clips 60a, b to allow the printer cartridge 52 to be inserted into the housing internal cavity. Once the printer cartridge 52 is fully inserted into the housing internal cavity, the clips 60a, b flex onto a cover 64 of the printer cartridge 52.

The printer cartridge 52 may define a base portion 66 (see FIG. 4) and two ribbon guide portions 68a, b (see FIGS. 4 and 5). The ribbon guide portions 68a, b may extend from opposed ends of the base portion 66. The base portion 66 and the two ribbon guides 68a, b may define a cartridge internal cavity, as shown in FIG. 4. The cartridge internal cavity may contain a ribbon 70. The ribbon 70 may define rolled portions 72a, b, first extended portions 74a, b and a second extended portion 76. The rolled portions 72a, b may reside or be positioned within the cartridge internal cavity. The first extended portions 74a, b may extend from the rolled portions 72a, b through the internal cavities of the two ribbon guide portions 68a, b and the second extended portion 76 may extend between distal portions 78a, b (see FIG. 4) of the two ribbon guide portions 68a, b.

The light source 50 contained within the printer cartridge 52 may be a light emitting diode (LED), electroluminescent lamp or other light source. As shown in FIG. 4, the light source 50 is an electroluminescent lamp. The light source 50 when illuminated may illuminate the internal cavity of the ribbon guide portion 68a and shine light through a notch 80 (see FIGS. 2, 4 and 5) formed in the distal portion 78a of the ribbon guide portion 68a. Referring now to FIG. 2, the light shining through the notch 80 directly illuminates the target area 34 of the printing mechanism. As such, the employee when attempting to align the time slot 48 to the target area 34 is able to see the target area 34 better because the light shining through the notch 80 lights up the target area 34.

The light of the light source 50 may also shine through an arrow shaped aperture 82 (see FIGS. 2 and 5) formed in the ribbon guide portion 68a. The arrow points downward and may be aligned with or directly above the target area 34. Accordingly, if the time slot 48 is aligned underneath the arrow, then the time slot 48 is also aligned to the target area 34. The illuminated arrow also helps employees know where to align the appropriate time slot 48. For example, without the illuminated arrow, the employee, looking through the print window 32, sees a plurality of electronic and mechanical components and may not know where to align the appropriate time slot 48. The illuminated arrow directs the employee's attention to the target area 34 below the illuminated arrow.

In use, the employee may grasp his/her respective time card 14. The time card 14 may then be inserted into the time card slot 42, and the appropriate time slot 48 aligned to the target area 34 of the printing mechanism 20 below the illuminated arrow. The light shining through the notch 80 also helps the employee see the appropriate time slot 48 and align the appropriate time slot 48 to the target area 34. Thereafter, the user or employee may press the print button 24 to traverse the printing mechanism 20 from the idle position to the print position. The printing mechanism 20 traverses to the print position and indicates the current time on the aligned time slot 40.

In another aspect of the present invention, the light source 50 may be selectively turned on and off by closing and opening a light source switch activated by a sensor (e.g., proximity sensor). The light source switch may be serially attached to the light source and may maintain electrical communication with the time clock power source when the proximity sensor senses a time card inserted into the time card slot. When the proximity sensor does not sense the inserted time card, then the first light source switch terminates the electrical communication between the light source and the time clock power source.

The description of the various embodiments of the present invention is presented to illustrate the preferred embodiments of the present invention, and other inventive concepts may be otherwise variously embodied and employed. For example, it is also contemplated within the scope of the present invention that the various aspects of the present invention discussed herein may be employed with a light source attached to an external surface of the printer cartridge. The appended claims are intended to be construed to include such variations except insofar as limited by the prior art.

What is claimed is:

1. A printer cartridge of a time clock for helping an employee align a time card time slot to a printing mechanism target area, the cartridge comprising:
a. a base portion and two ribbon guide portions attached to the base portion;
b. a ribbon attached to the base portion and the ribbon guide portions for imprinting a time onto the time card;
c. a light source attached to at least one of the ribbon guide portions to illuminate the time slot and the target area such that the employee may align the time slot to the target area; and
d. a connector electrically communicable with a power source of the time clock for providing electrical power to the light source.

2. The cartridge of claim 1 wherein at least one of the ribbon guide portions define an internal cavity and the light source is disposed inside the internal cavity.

3. The cartridge of claim 2 wherein the ribbon guide portion has a notch allowing light of the light source to shine therethrough to illuminate the time card inserted into a time card slot of the time clock.

4. The cartridge of claim 3 wherein the notch is formed on a distal portion of the ribbon guide portion.

5. The cartridge of claim 1 wherein at least one of the ribbon guide portions has an arrow shaped aperture allowing light of the light source to shine therethrough to indicate that the time slot of the time card should be aligned thereunder.

6. The cartridge of claim 5 wherein the arrow shaped aperture is pointed toward a distal portion of the ribbon guide portion.

7. The cartridge of claim 1 wherein the light source is an electroluminescent lamp.

8. The cartridge of claim 1 wherein the light source is a light emitting diode.

9. A time clock for imprinting time onto a time card time slot, the clock comprising:
a. a printer platen;
b. a printing mechanism disposed adjacent to the printer platen wherein the printer platen and the printing mechanism defines a time card slot, the printing mechanism including a printer cartridge comprising:
i. a base portion and two ribbon guide portions attached to the base portion;
ii. a ribbon attached to the base portion and the ribbon guide portions for imprinting the time onto the time card inserted in the time card slot;
iii. a light source attached to at least one of the ribbon guide portions to illuminate the time card time slot and the target area such that the employee may align the time card time slot to the target area; and
iv. a connector electrically communicable with a power source of the time clock for providing power to the light source.

10. The clock of claim 9 further comprising a sensor electrically connected to the light source and operative to activate the light source when the time card inserted into the time card time slot is sensed by the sensor.

11. The clock of claim 9 wherein the light source is normally on.
